(19) United States
(12) Patent Application Publication
(10) Pub. No.: US 2018/0088088 A1
(43) Pub. Date: Mar. 29, 2018

(54) GAS SENSOR AND GAS DETECTION METHOD

(71) Applicant: TAIYO YUDEN CO., LTD., Tokyo (JP)

(72) Inventors: Kenichi SHIMOMAI, Takasaki-shi (JP); Masashi HATTORI, Takasaki-shi (JP); Junji OSHITA, Takasaki-shi (JP)

(21) Appl. No.: 15/710,617

(22) Filed: Sep. 20, 2017

(30) Foreign Application Priority Data
Sep. 23, 2016 (JP) 2016-185086

(51) Int. Cl. G01N 29/32; G01N 29/22; G01N 29/036

(52) U.S. Cl. CPC G01N 29/326; G01N 2291/014; G01N 29/036; G01N 29/222

(57) ABSTRACT

A gas sensor is equipped with a first detection element which has a first oscillator and a first adsorption film provided on the first oscillator to adsorb a specific gas, and changes its resonance frequency according to the adsorption of the gas; a second detection element which has a second oscillator and a second adsorption film provided on the second oscillator to adsorb moisture in the gas, and changes its resonance frequency according to the adsorption of the moisture; a third detection element which has a third oscillator, and changes its resonance frequency according to the temperature of the gas; and a computing unit which corrects the change in the resonance frequency of the first detection element based on the change in the resonance frequency of the second detection element and the change in the resonance frequency of the third detection element.

### BACKGROUND

### Field of the Invention

The present invention relates to a gas sensor capable of compensating for temperature and humidity effects.

### Description of the Related Art

Among gas sensors that compensate for temperature and humidity effects, Patent Literature 1 describes a gas measurement apparatus that measures a target gas by calibrating the zero point of a gas sensor using a standard gas, for example. This gas measurement apparatus uses temperature and humidity sensors to measure the temperature and humidity of the target gas and those of the standard gas, and then subtracts from the output of an odor sensor the effects calculated based on the differences between the measured temperatures and humidities, as well as the offset component of the odor sensor, in order to compensate for the measurement error caused by the humidity difference and temperature difference between the standard gas and target gas.

### BACKGROUND ART LITERATURES

[Patent Literature 1] Japanese Patent Laid-open No. Hei 7-174673

### SUMMARY

However, the aforementioned gas measurement apparatus measures two types of gases—the standard gas and the target gas—and thus requires a means for generating the standard gas, and consequently the apparatus becomes large. Also, the temperature and humidity cannot be compensated for in real time if the output characteristics of the odor, temperature and humidity sensors vary, in which case a problem of poor detection accuracy with respect to the target gas that flows momentarily may occur, for example.

In light of the aforementioned situations, an object of the present invention is to provide a gas sensor adopting a simpler constitution and still capable of accurately detecting a target gas that flows momentarily, as well as a gas detection method using such sensor.

Any discussion of problems and solutions involved in the related art has been included in this disclosure solely for the purposes of providing a context for the present invention, and should not be taken as an admission that any or all of the discussion were known at the time the invention was made.

To achieve the aforementioned object, a gas sensor pertaining to an embodiment of the present invention is equipped with a first detection element, a second detection element, a third detection element, and a computing unit.

The first detection element has a first oscillator of a prescribed structure as well as a first adsorption film provided on the first oscillator to adsorb a specific gas, and changes its resonance frequency according to the adsorption of the gas.

The second detection element has a second oscillator of the prescribed structure as well as a second adsorption film provided on the second oscillator to adsorb moisture content in the gas, and changes its resonance frequency according to the adsorption of the moisture.

The third detection element has a third oscillator of the prescribed structure, and changes its resonance frequency according to the temperature of the gas.

The computing unit corrects the change in the resonance frequency of the first detection element based on the change in the resonance frequency of the second detection element and the change in the resonance frequency of the third detection element.

According to this constitution of the present invention, a change in resonance frequency which is free from temperature and humidity effects and pertains only to a gaseous substance can be calculated, and therefore the gas can be detected accurately.

In the first detection element, the resonance frequency of the first oscillator drops in proportion to the weight of the gas adsorbed on the first adsorption film, and therefore the adsorbed amount of the gas can be identified by detecting the amount of change in the resonance frequency of the oscillator; however, the resonance frequency of the first oscillator also fluctuates according to temperature and humidity, which means that the change in resonance frequency as detected by the first detection element includes a component that pertains only to the gaseous substance, a component that pertains to the temperature, and a component that pertains to the humidity.

Under the present invention, the resonance frequency of the first oscillator is corrected based on the detection result of the second detection element that compensates for humidity and the detection result of the third detection element that compensates for temperature, and therefore a change in resonance frequency which is free from temperature and humidity effects and pertains only to a gaseous substance can be calculated. As a result, the gas can be detected accurately.

In addition, use of oscillators whose structure is similar to that of the oscillator of the first detection element, for the second detection element, and third detection element used for compensation, provides detection elements with quick detection responsiveness. By using these detection elements in the gas sensor, a target gas can be detected accurately even when the gas flows momentarily.

The computing unit corrects the change in the resonance frequency of the second detection element based on the change in the resonance frequency of the third detection element, and then corrects the change in the resonance frequency of the first detection element based on the aforementioned correction result and the change in the resonance frequency of the third detection element.

As described above, the detection result of the second detection element used for humidity compensation may be corrected based on the detection result of the third detection element used for temperature compensation.

The second detection element changes its resonance frequency as moisture is adsorbed on the second adsorption film; however, it also has temperature dependency and its resonance frequency also fluctuates according to temperature. Accordingly, a more accurate detection result can be obtained by correcting, in advance, the detection result of the second detection element used for correcting the detection result of the first detection element, based on the detection result of the third detection element used for temperature compensation.

The first oscillator and second oscillator may each be constituted by an AT-cut quartz plate, while the third oscillator may be constituted by a quartz plate whose resonance frequency changes as a linear function of temperature change.

As mentioned above, an AT-cut quartz plate whose characteristics do not change at or around room temperature may be used for the first oscillator and for the second oscillator. And, for the third oscillator of the third detection element used for temperature compensation, a quartz plate whose resonance frequency changes as a linear function of temperature change may be used. For the quartz plate whose resonance frequency changes as a linear function of temperature change, a quartz plate whose cut angle is offset from the AT cut angle may be used, for example. This way, the temperature can be detected from the change in resonance frequency as detected from the third detection element.

There may further be a fourth detection element which has a fourth oscillator of a prescribed structure as well as a fourth adsorption film provided on the fourth oscillator to adsorb a specific gas different from the aforementioned gas, and which changes its resonance frequency according to the adsorption of the specific gas different from the aforementioned gas, and the computing unit may correct the change in the resonance frequency of the fourth detection element based on the change in the resonance frequency of the second detection element and the change in the resonance frequency of the third detection element.

As described above, the constitution may be such that multiple gas detection elements (first detection element and fourth detection element) are provided to detect a specific gas.

A gas detection method pertaining to an embodiment of the present invention involves detection of the change in the resonance frequency of the first detection element, detection of the change in the resonance frequency of the second detection element, detection of the change in the resonance frequency of the third detection element, correction of the detection result of the second detection element, correction of the detection result of the first detection element, and identification of the aforementioned gas.

The detection of the change in the resonance frequency of the first detection element, which has a first oscillator of a prescribed structure as well as a first adsorption film provided on the first oscillator to adsorb a specific gas, involves detecting the change in the resonance frequency of the first detection element due to the adsorption of the gas.

The detection of the change in the resonance frequency of the second detection element, which has a second oscillator of the prescribed structure as well as a second adsorption film provided on the second oscillator to adsorb moisture content in the gas, involves detecting the change in the resonance frequency of the second detection element due to the adsorption of the moisture.

The detection of the change in the resonance frequency of the third detection element, which has a third oscillator of the prescribed structure, involves detecting the change in the resonance frequency of the third detection element due to the temperature of the gas.

The correction of the detection result of the second detection element involves correcting the detection result of the second detection element based on the detection result of the third detection element.

The correction of the detection result of the first detection element involves correcting the detection result of the first detection element based on the aforementioned correction result and the detection result of the third detection element.

The identification of the gas is based on the detection result of the first detection element as corrected.

According to this constitution of the present invention, a change in resonance frequency which is free from temperature and humidity effects and pertains only to a gaseous substance can be calculated, and therefore the gas can be detected accurately.

The first oscillator and second oscillator are each constituted by an AT-cut quartz plate, while the third oscillator is constituted by a quartz plate whose resonance frequency changes as a linear function of temperature change.

As mentioned above, an AT-cut quartz plate whose characteristics do not change at or around room temperature may be used for the first oscillator and for the second oscillator. And, for the third oscillator of the third detection element used for temperature compensation, a quartz plate whose resonance frequency changes as a linear function of temperature change may be used. For the quartz plate whose resonance frequency changes as a linear function of temperature change, a quartz plate whose cut angle is offset from the AT cut angle may be used, for example. This way, the temperature can be detected from the third detection element.

As described above, according to the present invention even a target gas that flows momentarily can be detected accurately with a simpler constitution.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a front view of the detection element pertaining to an embodiment of the present invention.

FIG. 2 is a schematic diagram showing the constitution of the gas sensor pertaining to an embodiment of the present invention.

FIG. 3 is a conceptual drawing explaining how a gas is detected by the gas sensor shown in FIG. 2.

FIG. 4 is a flow chart showing the gas detection method pertaining to an embodiment of the present invention.

FIG. 5 is a diagram comparing the response speed, under rising temperature, of the temperature detection element using a quartz oscillator as used in the gas sensor shown in FIG. 2, and that of a temperature detection element using a thermistor as provided under a comparative example.

FIG. 6 is a diagram comparing the response speed, under falling temperature, of the temperature detection element using a quartz oscillator as used in the gas sensor shown in FIG. 2, and that of a temperature detection element using a thermistor as provided under a comparative example.

FIG. 7 is a diagram comparing the frequency change, under rising humidity, of the temperature detection element using a quartz oscillator as used in the gas sensor shown in FIG. 2, and that of a temperature detection element using a thermistor as provided under a comparative example.

FIG. 8 is a diagram comparing the response speed, under rising/falling humidity, of the humidity detection element using a quartz oscillator as used in the gas sensor shown in FIG. 2, and that of a humidity detection element of capacitance change type as provided under a comparative example.

FIG. 9 is a timing chart (1) for explaining the real-time correction, based on temperature and humidity detection elements, pertaining to an embodiment of the present invention.

FIG. 10 is a timing chart (2) for explaining the real-time correction, based on temperature and humidity detection elements, pertaining to an embodiment of the present invention.

FIG. 11 is a diagram showing the result, before correction, as detected by the ammonia gas detection element in the gas sensor shown in FIG. 2 when ammonia gas flows intermittently.

FIG. 12 is a diagram showing the result as detected by the temperature detection element in the gas sensor shown in FIG. 2 when ammonia gas flows intermittently.

FIG. 13 is a diagram showing the result as detected by the humidity detection element in the gas sensor shown in FIG. 2 when ammonia gas flows intermittently.

FIG. 14 is a diagram showing the result, after correction, as detected by the ammonia gas detection element in the gas sensor shown in FIG. 2 when ammonia gas flows intermittently.

FIG. 15 is a timing chart (1) for explaining the gas detection method using existing temperature/humidity sensors as provided under a comparative example.

FIG. 16 is a timing chart (2) for explaining the gas detection method using existing temperature/humidity sensors as provided under a comparative example.

### DESCRIPTION OF THE SYMBOLS

1a Gas detection element
1b Gas detection element
1c Gas detection element
6 Computing unit
13, 213 Quartz oscillator constituted by an AT-cut quartz plate
113 Quartz oscillator constituted by a quartz plate whose cut angle is offset from the AT cut angle
101 Temperature detection element
201 Humidity detection element

### DETAILED DESCRIPTION OF EMBODIMENTS

An embodiment of the present invention is explained below by referring to the drawings.

[Constitutions of Detection Elements]

The gas sensor pertaining to this embodiment is equipped with three types of detection elements including gas detection elements that each detect a specific gas, a temperature detection element for temperature compensation, and a humidity detection element for humidity compensation. The detailed structure of the gas sensor is described later.

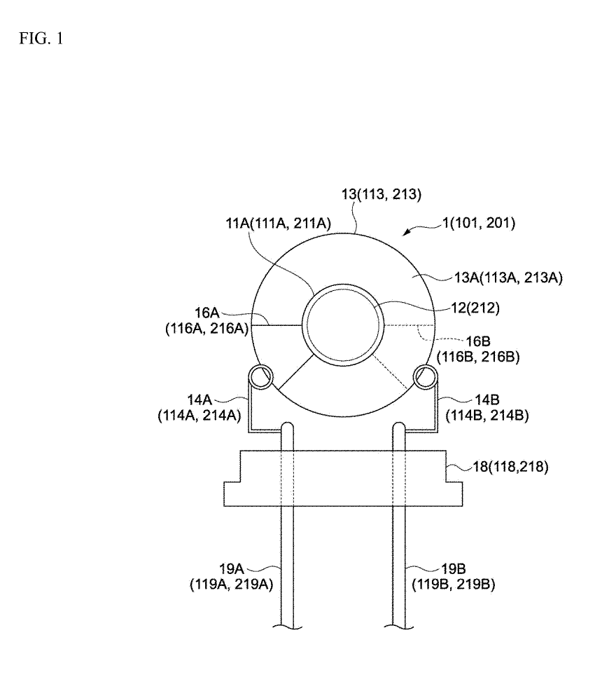

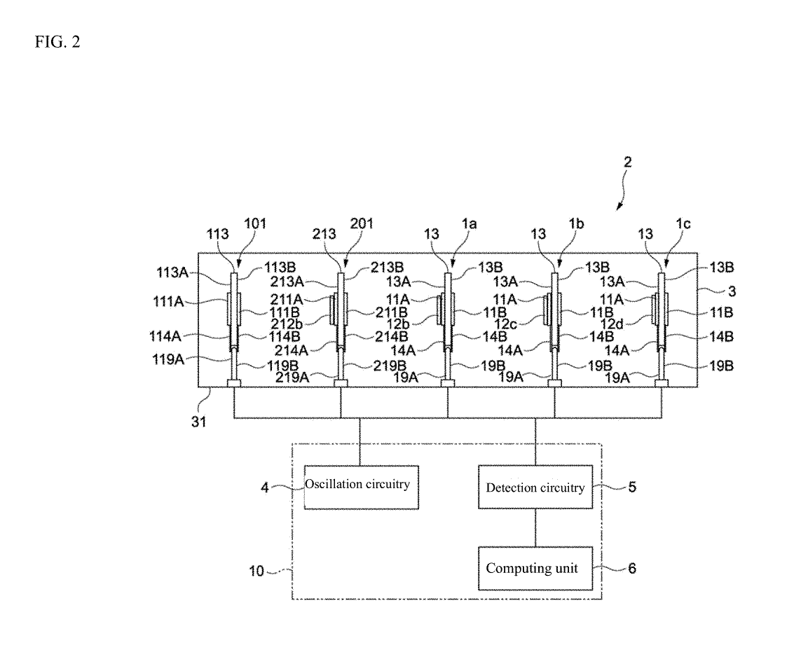

FIG. 1 is a front view showing a gas detection element 1 (gas detection elements 1a to 1c in FIG. 2 are collectively denoted by 1), temperature detection element 101 and humidity detection element 201. These detection elements 1, 101, 201 all have the same basic structure, with the differences being whether or not the element uses an adsorption film, and if it does, the type of adsorption film used.

FIG. 2 is a schematic diagram showing the constitution of the gas sensor. The constitutions of the respective detection elements are explained below one at a time.

As shown in FIGS. 1 and 2, the gas detection element 1 serving as the first detection element has a quartz oscillator 13 serving as the first oscillator, electrodes 11A (11B), an adsorption film 12, lead lands 16A, 16B, leads 14A, 14B, pin terminals 19A, 19B, and a base 18.

The quartz oscillator 13 is a quartz oscillator made of an AT-cut plate and having a resonance frequency of 9 MHz. The quartz oscillator 13 has a circular shape of 8.6 mm in diameter and 0.185 mm in thickness.

On opposing principal faces 13A, 13B of the quartz oscillator 13, the electrodes 11A, 11B, which are thin metal films that have been patterned to a prescribed shape, are formed, respectively. In this embodiment, gold was used as the electrode material. The electrodes 11A, 11B have a circular shape of 5.0 mm in diameter.

The adsorption film 12 is formed on the electrode 11A and adsorbs a specific gas.

The lead land 16A is integrally formed with the electrode 11A, while the lead land 16B is integrally formed with the electrode 11B.

The leads 14A, 14B are each made of a metal spring material and are placed in parallel with each other.

The lead 14A is constituted in such a way that one end is electrically connected to the electrode 11A via the lead land 16A, while the other end is connected to the pin terminal 19A. The lead 14B is constituted in such a way that one end is electrically connected to the electrode 11B via the lead land 16B, while the other end is connected to the pin terminal 19B.

The base 18 is made of an insulating member and has through holes that let the pin terminals 19A, 19B pass through. As the quartz oscillator 13 is held with the pin terminals 19A, 19B passing through the through holes in the base 18, the quartz oscillator 13 is vibratably supported by the base 18.

The pin terminals 19A, 19B of the gas detection element 1 are connected to an oscillation circuitry 4, and drive voltage is applied to the gas detection element 1. As drive voltage is applied to the gas detection element 1, the quartz oscillator 13 vibrates at its natural frequency (9 MHz).

Then, as the adsorption film 12 adsorbs gas and changes its mass, the resonance frequency of the quartz oscillator 13 drops according to the adsorbed amount of gas.

The gas detection elements 1a to 1c differ only in the type of their adsorption film 12a to 12c, and the remainder of the structure is the same. To be specific, the quartz oscillators 13 constituting the gas detection elements 1a to 1c all have the same diameter, thickness, resonance frequency, etc., and their electrodes 11A, 11B and lead lands 16A, 16B also have the same material, thickness, pattern shape, etc.

The adsorption film 12a is made of a copolymer formed with vinylidene fluoride resin (polyvinylidene fluoride; hereinafter referred to as “PVDF”) and trifluoroethylene (hereinafter referred to as “TrFE”). To be specific, the adsorption film 12a was formed by blending PVDF and TrFE at a blending ratio by weight of 8:2, dissolving the resulting copolymerized powder in methyl ethyl ketone to produce a solution, applying this solution with a spin coater over the electrode 11A to a prescribed thickness, which was 500 nm in this case, and then volatilizing the solvent in a drying oven.

The adsorption film 12b is made of a copolymer formed with PVDF, TrFE, and ethylene chloride trifluoride resin (polychlorotrifluoroethylene; hereinafter referred to as “PCTFE”). To be specific, the adsorption film 12b was formed by blending PVDF, TrFE, and PCTFE at a blending ratio by weight of 65:25:10, dissolving the resulting copolymerized powder in methyl ethyl ketone to produce a solution, applying this solution with a spin coater over the electrode 11A to a prescribed thickness, which was 500 nm in this case, and then volatilizing the solvent in a drying oven.

The adsorption film 12c is formed using a cyanine pigment. For the cyanine pigment, 1,1′-dibutyl 3,3,3′,3′-tetramethyl-4,5,4′,5′ dibenzoindodicarbocyanine bromide (Part Number NK3567 manufactured by Nippon Kankoh-Shikiso Kenkyusho Co., Ltd.) was used. The adsorption film 12c was formed by dissolving this cyanine pigment in tetrafluoropropanol (TFP) to produce a solution, applying this solution with a spin coater over the electrode 11A to a prescribed thickness, which was 500 nm in this case, and then volatilizing the solvent in a drying oven.

The adsorption film 12a, adsorption film 12b, and adsorption film 12c have the characteristics of adsorbing acetone, toluene, and ammonia, respectively, and in this embodiment, the gas detection element 1a, gas detection element 1b and gas detection element 1c are used for detecting acetone, toluene, and ammonia, respectively.

As shown in FIGS. 1 and 2, the temperature detection element 101 serving as the third detection element has a quartz oscillator 113 serving as the third oscillator, electrodes 111A (111B), lead lands 116A, 116B, leads 114A, 114B, pin terminals 119A, 119B, and a base 118. No adsorption film is formed on the temperature detection element 101.

The quartz oscillator 113 is a quartz plate whose resonance frequency changes as a linear function of temperature change, and in this embodiment, a quartz plate whose cut angle is offset from the AT cut angle is used. The quartz oscillator 113 has a circular shape of 8.6 mm in diameter and 0.185 mm in thickness, and its resonance frequency is 9 MHz.

On opposing principal faces 113A, 113B of the quartz oscillator 113, the electrodes 111A, 111B, which are thin metal films that have been patterned to a prescribed shape, are formed, respectively. In this embodiment, gold was used as the electrode material. The electrodes 111A, 111B have a circular shape of 5.0 mm in diameter.

The lead land 116A is integrally formed with the electrode 111A, while the lead land 116B is integrally formed with the electrode 111B.

The leads 114A, 114B are each made of a metal spring material and are placed in parallel with each other. The lead 114A is constituted in such a way that one end is electrically connected to the electrode 111A via the lead land 116A, while the other end is connected to the pin terminal 119A. The lead 114B is constituted in such a way that one end is electrically connected to the electrode 111B via the lead land 116B, while the other end is connected to the pin terminal 119B.

The base 118 is made of an insulating member and has through holes that let the pin terminals 119A, 119B pass through. As the quartz oscillator 113 is held with the pin terminals 119A, 119B passing through the through holes in the base 118, the quartz oscillator 113 is vibratably supported by the base 118.

The pin terminals 119A, 119B of the temperature detection element 101 are connected to the oscillation circuitry 4, and drive voltage is applied to the temperature detection element 101. As drive voltage is applied to the temperature detection element 101, the quartz oscillator 113 vibrates at its natural frequency (9 MHz). The resonance frequency of the temperature detection element 101 fluctuates according to temperature.

Since no adsorption film is formed on the temperature detection element 101, its resonance frequency does not change due to adsorption of gas, and the resonance frequency does not change due to adsorption of moisture, either. Also, the temperature detection element 101 uses, for its oscillator, a quartz plate whose cut angle is offset from the AT cut angle, where a quartz plate whose resonance frequency changes as a linear function of temperature change is suitable. This way, the temperature can be detected from the change in resonance frequency as detected by the temperature detection element 101.

As shown in FIGS. 1 and 2, the humidity detection element 201 serving as the second detection element has a quartz oscillator 213 serving as the second oscillator, electrodes 211A (211B), an adsorption film 212, lead lands 216A, 216B, leads 214A, 214B, pin terminals 219A, 219B, and a base 218.

The quartz oscillator 213 is a quartz oscillator made of an AT-cut plate. The quartz oscillator 213 has a circular shape of 8.6 mm in diameter and 0.185 mm in thickness, and its resonance frequency is 9 MHz.

On opposing principal faces 213A, 213B of the quartz oscillator 213, the electrodes 211A, 211B, which are thin metal films that have been patterned to a prescribed shape, are formed, respectively. In this embodiment, gold was used as the electrode material. The electrodes 211A, 211B have a circular shape of 5.0 mm in diameter.

The adsorption film 212 is formed on the electrode 211A. The adsorption film 212 is made of polyvinyl alcohol resin. The adsorption film 212 does not adsorb gas; instead, it adsorbs moisture.

The lead land 216A is integrally formed with the electrode 211A, while the lead land 216B is integrally formed with the electrode 211B.

The leads 214A, 214B are each made of a metal spring material and are placed in parallel with each other.

The lead 214A is constituted in such a way that one end is electrically connected to the electrode 211A via the lead land 216A, while the other end is connected to the pin terminal 219A. The lead 214B is constituted in such a way that one end is electrically connected to the electrode 211B via the lead land 216B, while the other end is connected to the pin terminal 219B.

The base 218 is made of an insulating member and has through holes that let the pin terminals 219A, 219B pass through. As the quartz oscillator 213 is held with the pin terminals 219A, 219B passing through the through holes in the base 218, the quartz oscillator 213 is vibratably supported by the base 218.

The pin terminals 219A, 219B of the humidity detection element 201 are connected to an oscillation circuitry described later, and drive voltage is applied to the humidity detection element 201. As drive voltage is applied to the humidity detection element 201, the quartz oscillator 213 vibrates at its natural frequency (9 MHz).

Then, as the adsorption film 212 adsorbs moisture and changes its mass, the resonance frequency of the quartz oscillator 213 drops according to the adsorbed amount of moisture.

As described above, the quartz oscillator 113 constituting the temperature detection element 101, and the quartz oscillator 213 constituting the humidity detection element 201, both have the same diameter, thickness, and resonance frequency as with the quartz oscillator 13 constituting the gas detection element 1 (gas detection elements 1a to 1c in FIG. 2). In addition, the electrodes 111A (211A), 111B (211B) and lead lands 116A (216A), 116B (216B) formed on these quartz oscillators 113 (213) are constituted in such a way that their material, thickness, pattern shape, etc., are the same as with the electrodes 11A, 11B and lead land 16A, 16B of the gas detection element 1. Thus, the oscillators of the detection elements 1, 101, 201 have the same prescribed structure, and they each have vibration characteristics that are recognized as virtually identical or equivalent.

It should be noted that, in this embodiment, a quartz oscillator was used as the oscillator constituting each detection element; however, the oscillator is not limited to the foregoing. For example, a ceramic oscillator, surface acoustic wave element, cantilever, diaphragm, or other vibration element that can detect increase in weight or expansive stress, or other physical change caused by adsorption of gas on the adsorption film and convert it to an electrical signal, can be applied besides a quartz oscillator. Again, in this case, the detection elements are each constituted by a vibration element of the same type.

[Constitution of Gas Sensor]

As shown in FIG. 2, the gas sensor 2 has a gas sensor unit 3 and a controller 10. The controller 10 is constituted by a computer with a CPU (central processing unit), memory, etc., and has an oscillation circuitry 4, a detection circuitry 5, and a computing unit 6.

The gas sensor 2 pertaining to this embodiment has multiple detection elements.

The multiple detection elements are specifically the gas detection elements 1a to 1c that each detect a specific gas, the humidity detection element 201 for humidity compensation, and the temperature detection element 101 for temperature compensation.

The constitutions of the gas detection elements 1a to 1c, temperature detection element 101, and humidity detection element 201 were described above and are therefore not explained.

The gas sensor unit 3 is equipped with a chamber 31, as well as the three gas detection elements 1a to 1c, temperature detection element 101, and humidity detection element 201, all of which are housed in the chamber 31. The chamber 31 houses the gas detection elements 1a to 1c that are placed with a prescribed spacing in between. The chamber 31 allows target gases to be introduced into its interior.

The oscillation circuitry 4 vibrates the quartz oscillators 13, 113, and 213 of the gas detection elements 1a to 1c, temperature detection element 101, and humidity detection element 201 at a prescribed frequency (resonance frequency: 9 MHz), respectively.

The detection circuitry 5 detects the resonance frequency, or change therein, of each of the gas detection elements 1a to 1c, temperature detection element 101, and humidity detection element 201.

When a gas or other target substance is adsorbed on any of the adsorption films 12a to 12c while the gas detection elements 1a to 1c are being vibrated at the prescribed frequency by the oscillation circuitry 4, the resonance frequency of the quartz oscillator 13 in the applicable gas detection elements 1a to 1c changes. An electrical signal corresponding to the detected resonance frequency is output to the computing unit 6 from the detection circuitry 5.

The temperature detection element 101 is vibrated at the prescribed frequency by the oscillation circuitry 4, and the resonance frequency of the quartz oscillator 213 is detected by the detection circuitry 5. An electrical signal corresponding to the detected resonance frequency is output to the computing unit 6 from the detection circuitry 5. The temperature can be obtained from the detection result of the temperature detection element 101 because its resonance frequency changes according to temperature.

When the detection target, or specifically moisture content in gas, is adsorbed on the adsorption film 212 while the humidity detection element 201 is being vibrated at the prescribed frequency by the oscillation circuitry 4, the resonance frequency of the quartz oscillator 213 changes. An electrical signal corresponding to the detected resonance frequency is output to the computing unit 6 from the detection circuitry 5.

The computing unit 6 calculates a change in resonance frequency which is free from temperature and humidity effects and pertains only to a gaseous substance, that has occurred at each gas detection element 1a to 1c, based on the electrical signals of each of the gas detection elements 1a to 1c, temperature detection element 101, and humidity detection element 201 that have been input from the detection circuitry 5, respectively, and identifies the type of the gas that was introduced into the chamber 31, from the calculated change in resonance frequency. The details of the processing that takes place in the computing unit 6 are explained later under “Gas Detection Method.”

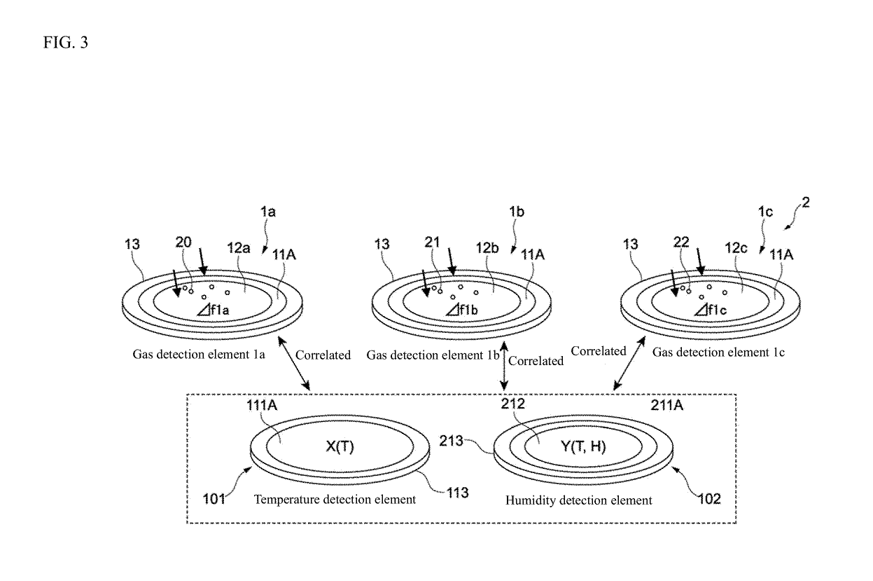

FIG. 3 is a conceptual drawing explaining how a gas is detected by the gas sensor shown in FIG. 2.

As shown in FIG. 3, the gas sensor 2 corrects the detection results of the gas detection elements 1a to 1c based on the detection results of the temperature detection element 101 and humidity detection element 201, respectively. To be specific, the temperature detection element 101 is used for temperature compensation, while the humidity detection element 201 is used for humidity compensation. In addition, the detection result of the humidity detection element 201 is corrected based on the detection result of the temperature detection element 101 before the detection results of the gas detection elements 1a to 1c are corrected, because the resonance frequency of the humidity detection element 201 fluctuates according to temperature.

In FIG. 3, symbols 20, 21, 22 indicate odor molecules in gases. In this embodiment, for example, the gas detection element 1a adsorbs the odor molecules (gaseous substance) 20 in acetone, the gas detection element 1b adsorbs the odor molecules (gaseous substance) 21 in toluene, and the gas detection element 1c adsorbs the odor molecules (gaseous substance) 22 in ammonia. This way, the gas sensor 2 in this embodiment can detect three types of specific gases that are different from one another.

(Gas Detection Method)

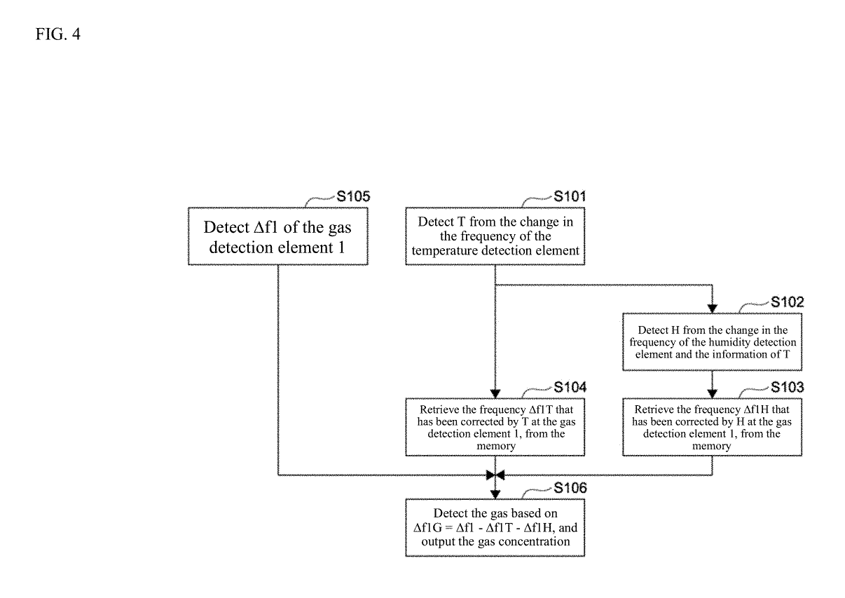

Next, how a gas is detected using the aforementioned gas sensor 2 is explained using FIGS. 2, 3, and 4. FIG. 4 is a flow chart showing the gas detection method. The explanation below follows the flow in FIG. 4.

First, the target gas is introduced into the chamber 31, and the oscillation circuitry 4 is actuated to vibrate the quartz oscillators 13, 113, 213 of the gas detection elements 1a to 1c, temperature detection element 101, and humidity detection element 201 at the prescribed frequency (resonance frequency: 9 MHz).

Next, the resonance frequencies of the gas detection elements 1a to 1c, temperature detection element 101 and humidity detection element 201 are detected by the detection circuitry 5. Electrical signals corresponding to the detected resonance frequencies are input to the computing unit 6. The subsequent steps S101 to S106 are performed for each of the gas detection elements 1a to 1c, and Δf1aG, Δf1bG, and Δf1cG, which are corrected versions of the resonance frequency changes Δf1a, Δf1b, and Δf1c detected at the respective gas detection elements 1a to 1c, are calculated through these detection steps. The gas detection elements 1a to 1c are hereinafter collectively referred to as “gas detection element 1,” unless they are explained separately.

The computing unit 6 detects the temperature (T) from the change in the resonance frequency of the temperature detection element 101 (S101). To be specific, the computing unit 6 references a table prepared beforehand showing the correspondence of temperatures and resonance frequencies at the temperature detection element 101, and detects the temperature of the gas based on the electrical signal from the temperature detection element 101. The table is stored in a memory (not illustrated) inside the controller 10, for example. In this embodiment, appropriate temperature compensation can be performed because a quartz plate whose resonance frequency changes as a linear function of temperature change is used as the oscillator 113 of the temperature detection element 101.

Next, the computing unit 6 detects the humidity (H) from the information of the detected temperature (T) and the frequency change at the humidity detection element 201 (S102). As described above, the resonance frequency of the humidity detection element 201 fluctuates according to temperature, and therefore the humidity (H) information free from temperature effects is detected in this step.

Next, the computing unit 6 retrieves from the memory the frequency that has been corrected by the humidity (H) at the gas detection element 1, or Δf1H, based on the humidity (H) information detected in S102 (S103). Stored in the memory is a table prepared beforehand, showing the correspondence of humidities (H) and corrected frequencies Δf1H at the gas detection element 1. This table is different for each of the gas detection elements 1a to 1c.

Also, the frequency that has been corrected by the temperature (T) at the gas detection element 1, or Δf1T, is retrieved from the memory based on the temperature (T) detected in S101 (S104). Stored in the memory is a table prepared beforehand, showing the correspondence of temperatures (T) and corrected frequencies Δf1T at the gas detection element 1. This table is different for each of the gas detection elements 1a to 1c.

Also, the computing unit 6 detects the resonance frequency change Δf1 from the resonance frequency of the gas detection element 1 as detected by the detection circuitry 5 (S105).

Next, the computing unit 6 uses Formula (1) below to calculate the frequency change Δf1G, which is free from temperature and humidity effects and pertains only to the gaseous substance, from the frequency change Δf1 of the gas detection element 1, corrected frequency pertaining to temperature Δf1T and corrected frequency pertaining to humidity Δf1H, and identifies the type of the target gas based on the calculation result, and calculates and outputs the gas concentration (S106).

[Mathematical Formula 1]

[symbol]

f1G= [symbol] f1−X(T)−Y(T,H) (1)

Now, the resonance frequency change Δf detected from the gas detection element is expressed as follows:

$$Δ f = - \frac{2 {f}_{0}^{2}}{\sqrt{ρμ} \cdot A} \cdot Δ m \qquad [ Mathematical Formula 2 ]$$

In the formula, Δf represents the amount of change in frequency. Δm represents the change in mass. f0 represents the basic frequency. ρ represents the density of the quartz. μ represents the shear stress of the quartz. A represents the electrode area. As shown, Δf is proportional to the change in the mass of the adsorption film due to the adsorption.

Also, as shown in Formula (2) below, the frequency change Δf1 detected from the gas detection element 1 (1a to 1c) includes temperature and humidity effects in addition to the gas adsorption effects. In other words, the frequency change Δf1 detected from the gas detection element 1 has a component corresponding to the resonance frequency change Δf1G which is free from temperature and humidity effects and pertains only to the adsorption of the gaseous substance, a component corresponding to the corrected frequency change pertaining to temperature Δf1T, and a component corresponding to the corrected frequency change pertaining to humidity Δf1H.

[Mathematical Formula 3]

[symbol]

f1= [symbol] f1G+ [symbol] f1T+ [symbol] f1H (2)

From (2):

[symbol]

f1G= [symbol] f1− [symbol] f1T− [symbol] f1H (3)

Using Formula (3) derived from Formula (2), the resonance frequency change Δf1G, which is due to the adsorption of the gas and free from temperature and humidity effects, is calculated by subtracting the corrected frequency change pertaining to temperature Δf1T and corrected frequency change pertaining to humidity Δf1H from the frequency change Δf1 detected from the gas detection element 1.

Δf1T is corrected by the temperature T calculated from the temperature detection element 101, and is obtained using a function of variable T. Δf1H is corrected by the humidity H calculated from the humidity detection element 201, and is obtained using a function of variable H. It should be noted that, because the humidity detection element 201 is affected by temperature, H is a function of T, where T corresponds to the T of the temperature detection element 101. As a result, Formula (1) mentioned above is derived.

In Formula (1) mentioned above, the function of the temperature detection element 101 (X) and that of the humidity detection element 201 (Y) are different for each of the gas detection elements 1a to 1c. This is because the adsorption films 12a to 12c provided in the respective gas detection elements 1a to 1c are different and the temperature and humidity effects vary with each of the gas detection elements 1a to 1c.

The computing unit 6 performs the calculation processing in S101 to S106 as described above, for each of the gas detection elements 1a to 1c. This way, the frequency changes Δf1aG, Δf1bG, Δf1cG of the gas detection elements 1a to 1c, which are free from temperature and humidity effects and pertain to the adsorption of the gas, are calculated.

In this embodiment, oscillators of the same structure are used for the temperature detection element 101 and humidity detection element 201, and therefore real-time detection becomes possible and a gas that flows momentarily can be detected accurately.

[Comparison of Temperature Detection Element of Quartz Oscillator Type and Temperature Detection Element of Thermistor Type]

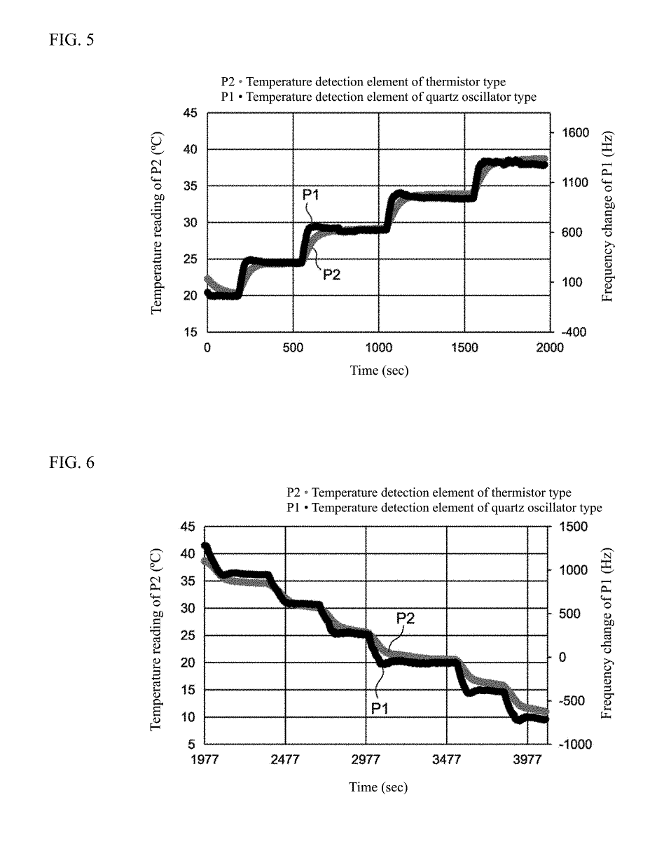

FIGS. 5 and 6 are diagrams comparing the response characteristics, under changing temperature, of the temperature detection element of quartz oscillator type P1 using a quartz oscillator as described in this embodiment (corresponding to the temperature detection element 101 in the embodiment), and that of a temperature detection element of thermistor type P2 as provided under a comparative example.

FIG. 5 shows how the frequency of the detection element P1 changes (right axis), and the output of the detection element P2 changes (left axis), when the temperature is raised in 5° C. increments under a condition of 50% in constant relative humidity RH. FIG. 6 shows how the frequency of the detection element P1 changes (right axis), and the output of the detection element P2 changes (left axis), when the temperature is lowered in 5° C. increments under a condition of 50% in constant relative humidity RH. Here, the P2 output is expressed by the “temperature reading (° C.).”

As shown in FIGS. 5 and 6, the temperature detection element of quartz oscillator type P1 responds more quickly to temperature change than the temperature detection element of thermistor type P2, under both rising temperature and falling temperature. The temperature detection element of thermistor type P2 responds more slowly than the temperature detection element of quartz oscillator type P1 with a delay of approx. 100 seconds, and being subject to this level of delay, the temperature detection element of thermistor type P2 is not suitable for real-time correction. An example is detecting a gas that flows momentarily, such as detecting exhaled air, where the temperature detection element of thermistor type P2 cannot accurately detect the temperature of a gas that flows momentarily and thus cannot perform accurate temperature correction.

Since an oscillator is used for the temperature detection element 101 in this embodiment, the gas temperature can be detected with relatively high responsiveness, even when detecting a gas that flows momentarily, such as detecting exhaled air. Furthermore, the temperature detection element 101 is constituted by an oscillator whose structure is the same as with the oscillator of the gas detection element 1, which allows for real-time temperature correction of the output from the gas detection element 1 and consequently a highly reliable gas detection result can be obtained.

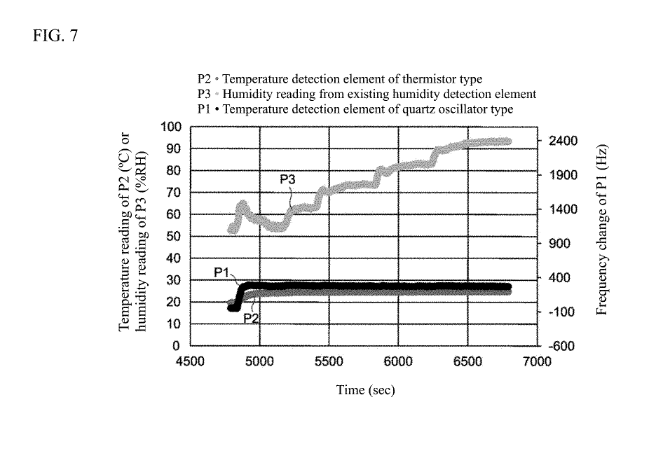

FIG. 7 is a diagram comparing the response characteristics, under changing humidity, of the temperature detection element of quartz oscillator type P1 using a quartz oscillator as described in this embodiment, and that of a temperature detection element of thermistor type P2 as provided under a comparative example. FIG. 7 also shows the humidity readings by an existing humidity sensor P3.

FIG. 7 shows how the frequency of the detection element P1 changes (right axis), and the outputs of the detection element P2 and sensor P3 change (left axis), when the relative humidity RH is raised in 10% increments from 50% to 90% under a condition of 25° C. in constant temperature. Here, the P3 output is expressed by the “humidity reading (% RH).”

As shown in FIG. 7, the temperature detection element of quartz oscillator type P1, and the temperature detection element of thermistor type P2, exhibit characteristics where the output plateaus and is no longer affected by humidity once the relative humidity reaches or exceeds a certain level.

[Comparison of Humidity Detection Element of Quartz Oscillator Type and Humidity Detection Element of Capacitance Change Type]

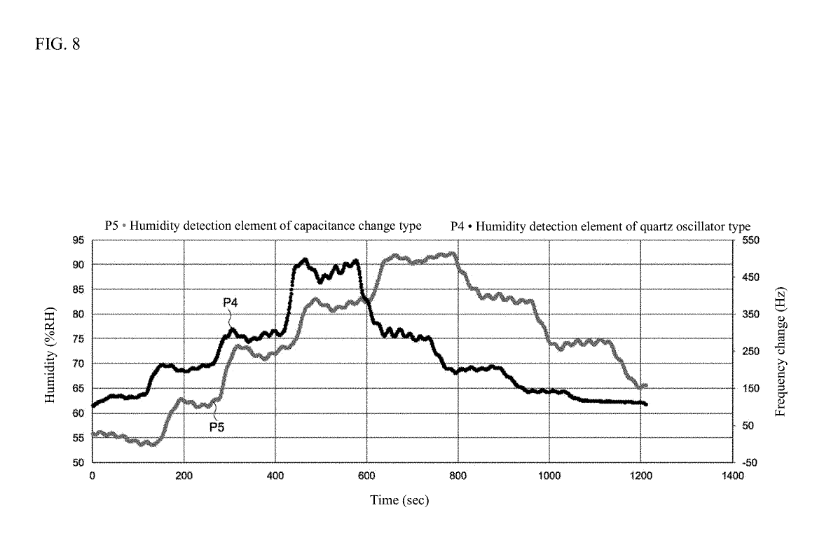

FIG. 8 is a diagram comparing the response characteristics, under changing humidity, of the humidity detection element of quartz oscillator type P4 using a quartz oscillator as described in this embodiment (corresponding to the humidity detection element 201 in the embodiment), and that of a humidity detection element of capacitance change type P5 as provided under a comparative example.

FIG. 8 shows how the frequency of the detection element P4 changes (right axis), and the output of the detection element P5 changes (left axis), when the relative humidity is raised in 10% increments from 50% to 90%, and then lowered in 10% increments from 90% to 50%, under a condition of 25° C. in constant temperature.

As shown in FIG. 8, the humidity detection element of quartz oscillator type P4 responds quicker to humidity change than the humidity detection element of capacitance change type P5, under both rising humidity and falling humidity. The humidity detection element of capacitance change type P5 responds more slowly than the humidity detection element of quartz oscillator type P4 with a delay of approx. 50 seconds, and being subject to this level of delay, the humidity detection element of capacitance change type P5 is not suitable for real-time correction. An example is detecting a gas that flows momentarily, such as detecting exhaled air, where the humidity detection element of capacitance change type P5 cannot accurately detect the humidity of the gas that flows momentarily and thus cannot perform accurate humidity correction.

Since an oscillator is used for the humidity detection element 201 in this embodiment, the gas humidity can be detected with relatively high responsiveness, even when detecting a gas that flows momentarily, such as detecting exhaled air. Furthermore, the humidity detection element 201 is constituted by an oscillator whose structure is the same as with the oscillator of the gas detection element 1, which allows for real-time humidity correction of the output from the gas detection element 1 and consequently a highly reliable gas detection result can be obtained.

[Explanation of Real-Time Correction in this Embodiment]

Next, the real-time correction for gas detection in this embodiment where oscillators are used for the temperature detection element and humidity detection element, is explained in contrast with a comparative example.

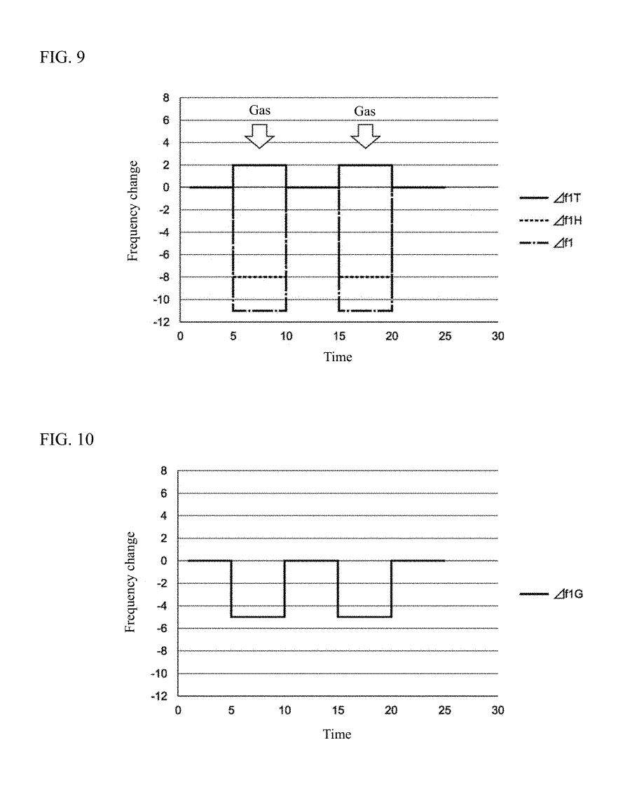

FIGS. 9 and 10 are used for explaining the aforementioned calculation of Δf1G in this embodiment. FIGS. 9 and 10 are timing charts for explaining the real-time correction with the temperature detection element 101 and humidity detection element 201, each using a quartz oscillator, where FIG. 9 is a timing chart before correction and FIG. 10 is a timing chart after correction.

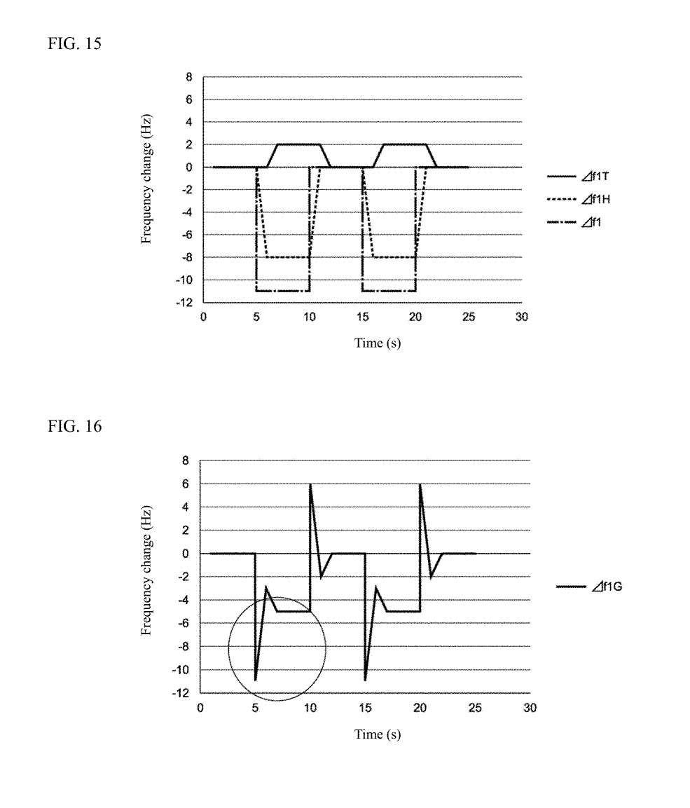

FIGS. 15 and 16 are used for explaining the calculation of Δf1G under a comparative example where a temperature detection element of thermistor type and a humidity detection element of capacitance type are used. FIGS. 15 and 16 are timing charts when a temperature detection element of thermistor type and a humidity detection element of capacitance type are used, where FIG. 15 is a timing chart before correction and FIG. 16 is a timing chart after correction.

In FIG. 9, the solid line represents Δf1T, the dotted line represents Δf1H, and the dashed-dotted line represents Δf1. Δf1T is obtained in step S104 described above. Δf1H is obtained in step S103 described above. Δf1 is obtained in step S105 described above. As shown in FIG. 9, these Δf1T, Δf1H and Δf1 are detected in real time as the gas is introduced. And, from Δf1T, Δf1H and Δf1 shown in FIG. 9, Δf1G which is calculated in step S106 as described above, is calculated in real time as the gas is introduced.

Thus, the gas sensor in this embodiment whose temperature detection element and humidity detection element each use a quartz oscillator similar to the one used for the gas detection element, calculates Δf1G based on real-time temperature compensation and humidity compensation.

On the other hand, how the gas sensor in the comparative example using a temperature detection element of thermistor type and a humidity detection element of capacitance type calculates Δf1G, is explained using the timing charts shown in FIGS. 15 and 16. As shown in FIG. 15, Δf1H (shown by dotted line) and Δf1T (solid line) are output with a time delay relative to Δf1 (dashed-dotted line). As a result, Δf1G that has been calculated from these Δf1, Δf1H and Δf1T draws the timing chart shown in FIG. 16. This indicates that the temperature compensation by the temperature detection element of thermistor type, and the humidity compensation by the humidity detection element of capacitance type, are unable to catch up. Accordingly, the resonance frequency change reflecting only the gaseous substance adsorbed on the gas detection element cannot be detected accurately.

As described above, use of oscillators for the temperature detection element and humidity detection element permits real-time gas detection, and consequently accurate gas detection becomes possible.

[Example of Detection of Ammonia Gas Using the Gas Sensor in this Embodiment]

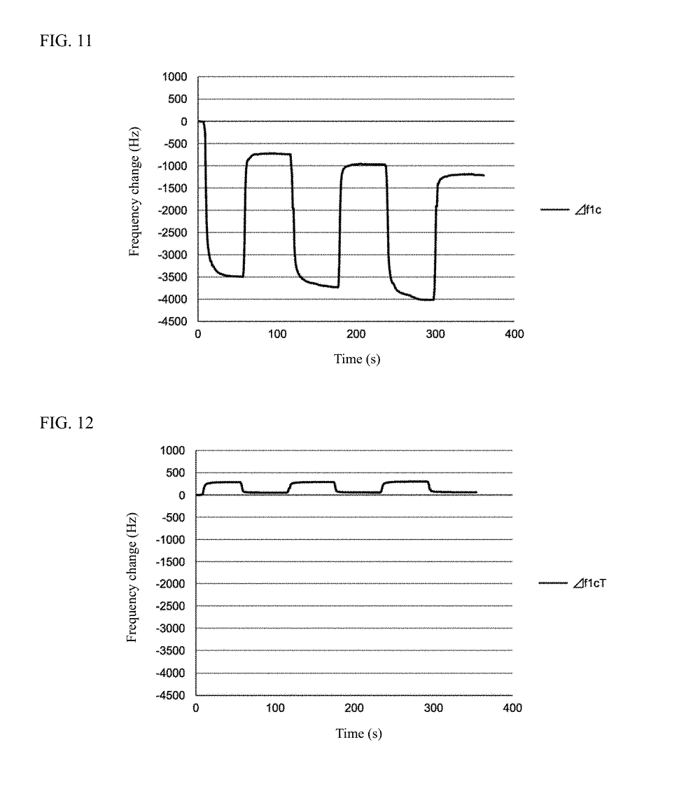

Next, the result of an experiment where, for example, ammonia gas was introduced into the chamber 3 of the aforementioned gas sensor 2, is explained. The following primarily explains the calculation of Δf1cG using FIGS. 11 to 14. In this experiment, the chamber ambience was set to 20° C. in temperature and 50% in relative humidity RH, and ammonia gas of 25° C. in temperature and 70% in relative humidity RH flowed intermittently.

Ammonia gas is adsorbed on the adsorption film 12c of the gas detection element 1c, and thus detected. Δf1cG is calculated through steps S101 to S106 as described above.

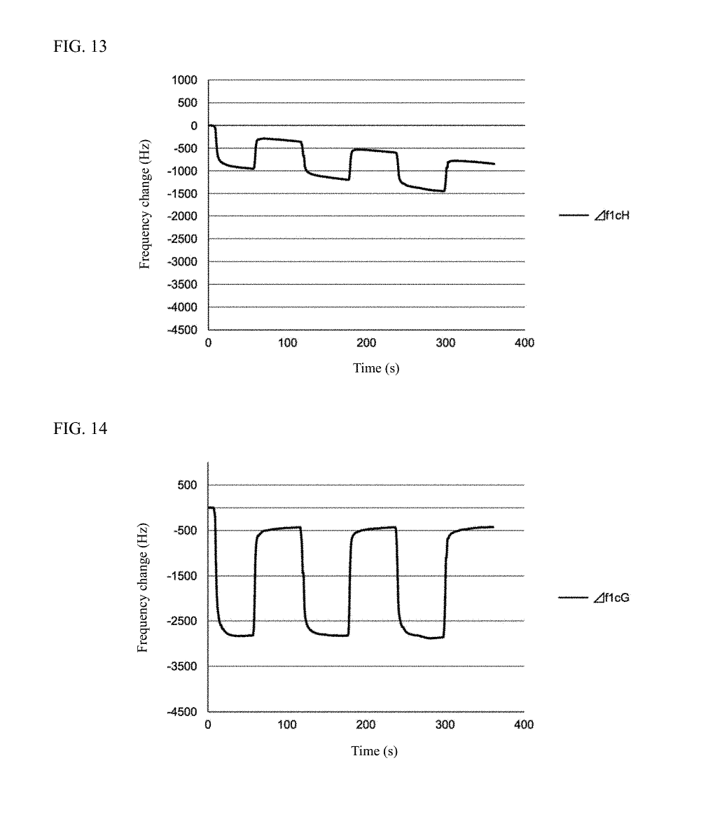

FIG. 11 shows Δf1c representing the frequency change before correction, which is detected by the gas detection element 1c in step S105. FIG. 12 shows Δf1cT detected in step S104. FIG. 13 shows Δf1cH detected in step S103. FIG. 14 shows Δf1cG representing the frequency change after correction, which is calculated in step S106.

As shown in FIGS. 11 to 13, Δf1c, Δf1cT and Δf1cH fluctuate as the introduction of ammonia gas into the chamber 3 is turned on and off. As shown in FIG. 11, Δf1c gradually increases with the passing of time regardless of whether the introduction of ammonia gas is on or off.

As shown in FIG. 12, the frequency change represented by Δf1cT takes a virtually constant value during the period when the introduction of ammonia gas is on, and this frequency change also takes a virtually constant value during the period when the introduction of ammonia gas is off. This indicates that the temperature detected by the temperature detection element 101 corresponds to the temperature of ammonia gas during the period when the introduction of ammonia gas is on, while it corresponds to the set temperature in the chamber during the period when the introduction of ammonia gas is off.

As shown in FIG. 13, the frequency change represented by Δf1cH gradually increases with the passing of time regardless of whether the introduction of ammonia gas is on or off. This indicates that the ambient humidity gradually increases with the passing of time. Accordingly, as the ambient humidity rises, the value of Δf1c gradually increases with the passing of time, as shown in FIG. 11. In other words, Δf1c is affected by humidity.

FIG. 14 shows that Δf1cG, which is calculated by correcting Δf1c using Δf1cH and Δf1cT, takes a virtually constant value during both periods when the introduction of ammonia gas is on and off. By performing temperature compensation and humidity compensation this way, the frequency change which is free from temperature and humidity effects and pertains only to the adsorption of the gaseous substance, can be calculated.

As described above, in this embodiment the equipment of the temperature detection element and humidity detection element, each having an oscillator of the same structure as that of the gas detection element, allows for temperature correction and humidity correction in real time to calculate the resonance frequency change which is free from temperature and humidity effects and pertains only to the adsorption of the gaseous substance, so that this calculation result can be used to identify the gas. As a result, accurate gas detection is possible with a simple constitution.

In addition, this embodiment where such real-time correction is possible can also be applied to detection of a gas that flows momentarily, and accurate gas detection becomes possible.

Also, in the aforementioned embodiment, the detection result of the humidity detection element is corrected using the detection result of the temperature detection element, after which the detection result of the gas detection element is corrected based on the corrected detection result of the humidity detection element and the detection result of the temperature detection element; accordingly, more accurate gas detection becomes possible.

The foregoing explained an embodiment of the present invention; however, it goes without saying that the present invention is not limited to the aforementioned embodiment and various changes can be added to it. The aforementioned embodiment used an example of a gas sensor in which three types of gas detection elements were provided; however, there may be one gas detection element or multiple gas detection elements.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2016-185086, filed Sep. 23, 2016, the disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A gas sensor, comprising:
a first detection element which has a first oscillator of a prescribed structure as well as a first adsorption film provided on the first oscillator to adsorb a first gas, wherein a resonance frequency of the first oscillator changes according to an adsorption of the first gas;
a second detection element which has a second oscillator of the prescribed structure as well as a second adsorption film provided on the second oscillator to adsorb moisture content in the gas, wherein a resonance frequency of the second oscillator changes according to an adsorption of the moisture; and
a third detection element which has a third oscillator of the prescribed structure, wherein a resonance frequency of the third oscillator changes according to a temperature of the gas.

2. A gas sensor according to claim 1, further comprising a fourth detection element which has a fourth oscillator of the prescribed structure as well as a fourth adsorption film provided on the fourth oscillator to adsorb a second gas different from the first gas, wherein a resonance frequency of the fourth oscillator changes according to an adsorption of the second gas.

3. A gas sensor according to claim 1, comprising a computing unit which corrects a change in the resonance frequency of the first detection element based on a change in the resonance frequency of the second detection element and a change in the resonance frequency of the third detection element.

4. A gas sensor according to claim 3, wherein the computing unit corrects a change in the resonance frequency of the fourth detection element based on a change in the resonance frequency of the second detection element and a change in the resonance frequency of the third detection element.

5. A gas sensor according to claim 3, wherein the computing unit corrects a change in the resonance frequency of the second detection element based on a change in the resonance frequency of the third detection element, and then corrects a change in the resonance frequency of the first detection element based on the aforementioned correction result and the change in the resonance frequency of the third detection element.

6. A gas sensor according to claim 1, wherein:
the first oscillator and second oscillator are each constituted by an AT-cut quartz plate; and
the third oscillator is constituted by a quartz plate whose resonance frequency changes as a linear function of temperature change.

7. A gas detection method comprising:
detecting a change in a resonance frequency of a first detection element which has a first oscillator of a prescribed structure as well as a first adsorption film provided on the first oscillator to adsorb a specific gas, due to an adsorption of the gas;
detecting a change in a resonance frequency of a second detection element which has a second oscillator of the prescribed structure as well as a second adsorption film provided on the second oscillator to adsorb a moisture content in the gas, due to an adsorption of the moisture;
detecting a change in a resonance frequency of a third detection element which has a third oscillator of the prescribed structure, due to a temperature of the gas;
correcting a detection result of the second detection element based on a detection result of the third detection element;
correcting a detection result of the first detection element based on the aforementioned correction result and the detection result of the third detection element; and
identifying the gas from the corrected detection result of the first detection element.

8. A gas detection method according to claim 7, wherein:
the first oscillator and second oscillator are each constituted by an AT-cut quartz plate; and
the third oscillator is constituted by a quartz plate whose resonance frequency changes as a linear function of temperature change.
